(19) United States
(12) Patent Application Publication
(10) Pub. No.: US 2024/0395524 A1
(43) Pub. Date: Nov. 28, 2024

(54) PROCESS AND DEVICE FOR DETECTING AN OPERATING STATE OF A PHOTOIONIZATION DETECTOR

(71) Applicant: Dräger Safety AG & Co. KGaA, Lübeck (DE)

(72) Inventors: Andre PAPE, Lübeck (DE); Tanja WESTERKAMP, Lübeck (DE)

(21) Appl. No.: 18/672,208

(22) Filed: May 23, 2024

(30) Foreign Application Priority Data
May 25, 2023 (DE) 10 2023 113 674.7

(51) Int. Cl. H01J 49/02; G01N 27/66; G01N 30/64

(52) U.S. Cl. CPC H01J 49/022; G01N 27/66; G01N 30/64; H01J 49/025; G01N 2030/642

(57) ABSTRACT

A process for detecting an operating state of a photoionization detector (1) with a lamp (6) for generating ultraviolet light. The Process comprises the following steps: changing an operating voltage of the photoionization detector (1) in a voltage range and measuring a resulting operating current (20, 21) of the photoionization detector (1), evaluating an operating state of the photoionization detector (1) on the basis of a course of the operating current (20, 21), and generating a result value which has at least one piece of information about the operating state of the photoionization detector (1) in relation to a switched-on state of the lamp (6). The invention also relates to a photoionization detector (1) with a device (2) and a gas measuring device (30) with a photoionization detector (1) and a device (35), which are designed to carry out the process.

### CROSS REFERENCE TO RELATED APPLICATIONS

This application claims the benefit of priority under 35 U.S.C. § 119 of German Application 10 2023 113 674.7, filed May 25, 2023, the entire contents of which are incorporated herein by reference.

### TECHNICAL FIELD

The present invention relates to a process for detecting an operating state of a photoionization detector, a photoionization detector with a device for detecting an operating state of the photoionization detector, and a gas measuring device (gas detecting device/gas detector) with a photoionization detector and a device for detecting an operating state of the photoionization detector.

### BACKGROUND

Such Photoionization detectors (PID) are used for the detection of volatile organic compounds (VOC). Such compounds are contained in vapors associated with paint thinners, nail polish removers or even gasoline (petrol), diesel and heating oil. VOCs also include numerous toxic substances such as benzene, hexane, toluene, xylene and many others. Some of these substances are acutely toxic even in low concentrations. A common and increasingly common application in which a PID is used to detect such substances is workplace monitoring. Establishing and adhering to exposure limits in the workplace is intended to protect employees who are exposed to hazardous substances from negative health consequences. A reliable measurement process is essential for this.

The functionality of a PID is based on the fact that molecules of organic substances in the air are ionized in a measuring chamber by high-energy ultraviolet light (UV light), i.e. broken down into charged fragments. A lamp, for example a gas discharge lamp, in the PID is used to generate the UV light. The ionized fragments travel in a gas flow between two electrodes to which an electrical voltage is applied and are discharged there. This causes a current to flow, which is greater the more ionized molecules are present. With the help of electronics, this current is converted into a signal that corresponds to the concentration of ionized molecules. A molecule can only be ionized if the energy of the irradiated light exceeds the substance-specific ionization threshold.

An essential component of a PID is therefore its lamp for generating UV light. To ensure its correct operation, it must be reliably guaranteed that the lamp ignites and UV light is generated accordingly. Low-pressure gas discharge lamps are typically used. The disadvantages of such lamps are their limited service life and their limited operational capability at different ambient temperatures. The latter can result in the lamp igniting at a certain ambient temperature, but not at another, particularly at lower ambient temperatures. It cannot therefore be assumed that the lamp will always ignite reliably and generate the UV light required to successfully measure the VOC concentration. A non-ignited lamp and therefore a non-functioning PID represents a particular safety risk, as the measurement signal of the PID is comparable to a measurement signal in typical ambient air when the lamp is not ignited. In this case, it is therefore not possible for a user to recognize from the measurement signal that the PID is not functional. If toxic substances are present in the environment of the user and the PID, the PID would not be able to detect them and would continue to show a measurement signal corresponding to non-hazardous ambient air. The user would therefore be in great danger, as they would not recognize any reason to initiate measures for their safety based on the measurement signal.

To detect whether a lamp has ignited and the PID is capable of measuring, a process is known in which the PID is exposed to a suitable test gas, i.e. a gas containing at least one volatile organic compound that can be detected by the PID, and the operating state of the PID can be determined on the basis of the changing measurement signal. This involves checking whether the measurement signal changes when the PID is exposed to the test gas. These manual function tests are particularly common in safety-critical applications and are largely mandatory. The disadvantage of this is the cost of the test gas used and the time required for such a function test, which is typically carried out regularly.

Furthermore, a process is known from U.S. Pat. No. 5,773,833A which uses an additional electrode within the measuring chamber of the PID to measure the light output of the lamp and thus provides information about the measuring capability of the PID. The UV light from the lamp strikes an additional electrode arrangement inside the PID and generates a photocurrent, the formation of which is based on the external photoelectric effect. The optical emission power of the lamp is therefore measured. Such a measurement can be influenced by a variety of physical disturbance variables, such as contamination and/or condensation. This affects the measurement and therefore the evaluation of the operating status of the PID. Furthermore, an additional electrode inside the measuring chamber and the associated electronics require a technically complex setup, which leads to higher manufacturing costs and therefore generally to higher costs for the PID.

### SUMMARY

Based on the solutions known from the prior art and the problems described above, it is an object of the invention to provide a process for detecting an operating state of a PID, with which it can be reliably determined whether its lamp, which emits the UV light required for measuring the PID, has ignited and the PID is therefore capable of measurement. A PID with a device and a gas measuring device (gas detecting device) with a PID and a device for reliably detecting ignition of the PID's lamp should also be specified. In each case, it should be determined in a reliable manner whether the lamp has ignited and the PID is therefore capable of measurement.

The foregoing problem is solved by a process having features according to the invention, a photoionization detector with a device having features according to the invention and a gas measuring device with a photoionization detector and a device having features according to the invention. Further details of the invention can be seen from this disclosure, including the description and the drawings. Features and details which are described in connection with the process according to the invention naturally also apply in connection with the PID according to the invention with a device and the gas measuring device according to the invention with a PID and a device, so that reference is always made or rather can be made to the individual aspects of the invention mutually with regard to the disclosure.

A process according to the invention detects the operating state of a photoionization detector with a lamp for generating ultraviolet light. Such a process comprises the following steps:
changing an operating voltage of the photoionization detector in a voltage range and measuring a resulting operating current of the photoionization detector,
evaluation of an operating state of the photoionization detector on the basis of a course (curve) of the operating current, and
generation of a result value which has at least one piece of information (comprises information) about the operating state of the photoionization detector in relation to a switched-on state of the lamp.

Operating current refers to both the current applied to the PID and the current applied to the lamp. Both are essentially proportional to each other and are equivalent in the context of the process according to the invention. Accordingly, operating voltage means both the voltage applied to the PID and the voltage applied to the lamp.

A lamp within the meaning of the invention is understood to be a gas discharge lamp, in particular a low-pressure gas discharge lamp, which is typically used in photoionization detectors. Such a lamp is based on the principle of gas discharge, whereby a low-pressure gas discharge lamp requires a lower ignition voltage compared to other gas discharge lamps. The ignition voltage indicates the voltage at which the lamp ignites, i.e. emits UV light. Due to the fact that the voltage applied to the lamp is essentially proportional to the voltage applied to the PID, the ignition voltage also refers to the voltage applied to the PID that causes the lamp to ignite.

As part of the invention, it was recognized that the operating state of a PID can be checked particularly reliably and safely by evaluating the course of the operating current as the operating voltage changes. This determines whether the lamp has ignited, i.e. is switched on and emitting UV light, or whether it has not ignited, i.e. is switched off and not emitting UV light. The latter case occurs, for example, if the lamp is defective.

If the lamp of the PID is not ignited, the operating current is essentially linear with a uniform change in the operating voltage. In other words, as the operating voltage changes uniformly, the operating current also changes uniformly until it reaches a maximum value specific to a particular PID. A uniform change in the operating voltage means that successive operating voltage values differ by an essentially identical value, for example by 0.1 volt per change in the operating voltage.

If, in contrast, a functioning lamp is present, the course of the operating current with changing operating voltage before the ignition voltage is reached differs from the course of the operating current after the ignition voltage is reached. If the operating voltage is lower than the ignition voltage and the lamp is switched off, the operating current changes essentially linearly with a changing operating voltage, as described above. If the operating voltage is greater than or equal to the ignition voltage and the lamp is switched on, the operating current is also essentially linear with a changing operating voltage greater than the ignition voltage, but the change in the operating current is greater than before the ignition voltage was reached if the operating voltage remains the same. With the same value change in the operating voltage, the resulting change in the operating current after ignition of the lamp is therefore greater than the resulting change in the operating current before ignition of the lamp. Accordingly, the slope of the operating current course before ignition of the lamp is smaller than the slope of the operating current course after ignition of the lamp.

Furthermore, the operating current at the time of ignition, i.e. at the time when the ignition voltage is reached and the lamp emits UV light for the first time, increases abruptly, for example by more than twice the average previous change in the operating current with a uniform change in the operating voltage.

The process according to the invention uses the effects described above in relation to the change in the operating current as a function of the operating voltage in order to detect the ignition of a lamp and thus the operating state of a PID in a reliable and simple manner.

In the first process step, the operating voltage is changed in a voltage range that depends on the respective PID and the resulting operating current is measured. Here, the operating voltage is increased from zero volts, for example, up to the maximum permissible operating voltage of the PID. This has the advantage that the PID is then ready to measure, provided that the lamp has ignited. The operating voltage may also be reduced, for example from the maximum permissible operating voltage of the respective PID to almost zero volts. In this way, the process advantageously offers the possibility of evaluating the operating state of the PID when it is switched on and/or when it is switched off. In both cases, the operating current is measured at least partially during the change in the operating voltage in the first step of the process.

The voltage range in which the operating voltage is changed is, for example, between zero volts and the maximum permissible operating voltage specified for the respective PID or the respective lamp. However, the range is at least between a voltage value below a typical ignition voltage for the respective lamp and a voltage value above a typical ignition voltage for the respective lamp. A typical ignition voltage is, for example, in a range of 50% to 75% of the permissible operating voltage of a PID. This ensures that, provided the lamp is able to ignite, the voltage range covers the ignition voltage and the course of the operating current changes as described above.

According to a particular embodiment, the measurement of the operating current takes place at almost identical time intervals. For example, the operating current is measured at intervals of almost one second, particularly advantageously at intervals of less than one second, for example almost: 0.75 seconds or 0.5 seconds or 0.25 seconds or 0.1 seconds. Alternatively, it is possible to measure the operating current at least almost every time the operating voltage changes.

In a further step, the course of the operating current is evaluated, whereby it is reliably determined whether the lamp has ignited. Several approaches are advantageously possible for this.

A special variant or similar of the process is the evaluation of the changes in the operating current, whereby the differences of directly successive measurements of the operating current are formed and the differences are compared with each other. The operating voltage is changed uniformly, and it should be determined whether a jump in the operating current has occurred, as is the case when the lamp is ignited, and/or whether the slope (gradient) of the operating current course changes. If the differences differ by double or more, for example, the lamp has ignited and caused a sudden increase in the operating current. If the differences in the operating currents differ less significantly, but by at least 15%, for example, it can be seen that the slope of the operating current course has changed, and the lamp has also ignited. If the differences in the operating currents are almost the same, i.e. the difference in the differences is less than 15%, for example, the lamp has not ignited, and the operating current course is essentially linear. The operating state of the PID can therefore be easily assessed on the basis of the operating current course.

A particularly advantageous variant of evaluating the operating state of the PID based on the operating current course involves determining the time at which a previously defined reference current has been set during operation of the PID. The reference current is determined, for example by empirical determination, in such a way that the lamp of the PID should already have ignited at this reference current. Accordingly, the reference current is greater than the operating current resulting from the ignition voltage of the PID. Alternatively or in addition, a time period may be determined in which this state is reached. During the evaluation, the time and/or period at which the operating current has actually reached the value of the reference current is compared with a calculated reference time and/or reference period at which the reference current would have been reached if the lamp had not ignited. Such a calculated reference time and/or reference period is determined with the aid of a linear equation, which is set up on the basis of the operating current course over time. This is based on a time range in which the operating voltage is significantly lower than the typical ignition voltage of the PID's lamp. In other words, in the time range in which the lamp cannot be switched on because the operating voltage is too low and therefore does not emit any UV light. The linear equation is used to interpolate the operating current course and calculate the reference time and/or reference period. The reference time and/or the reference period indicate when the previously defined reference current is reached on the basis of the linear equation. If the time or period at which the operating current actually reaches the value of the reference current is less than the calculated reference time or reference period, it is determined that the lamp has ignited. The value of the time difference at which the ignition of the lamp is determined depends on the respective change in the operating voltage and the specified reference current. As described above, the reference current is reached much earlier during operation of the PID with increasing operating voltage in the case of an ignited lamp due to the sudden increase and the changing slope of the operating current than in the case that the lamp has not ignited.

Further evaluation variants based on the already described characteristic properties of the operating current course when the operating voltage changes may be provided, without this restricting the general technical idea underlying the invention. What is always essential is the evaluation of the operating state of the PID based on the course of the operating current with changing operating voltage. Accordingly, the process can advantageously be implemented flexibly according to the circumstances and requirements and also offers the possibility of evaluating the measured operating current, which changes depending on a change in the operating voltage, in different ways and/or several times, for example also in order to check the result of an evaluation.

Based on the evaluation of the operating state of the PID using the course of the operating current, a result value is generated in accordance with the invention, which reflects the operating state of the PID or at least provides information about the operating state. If the evaluation has shown that the lamp has ignited, the PID is able measure and the result value is positive. If the evaluation has shown that the lamp has not ignited, the PID is not able to measure and the result value is negative.

A particular advantage of the process according to the invention is that only a few components are required to detect the operating state of the PID. In particular, no additional components are required within the measuring chamber of the PID, which are complex to integrate. This means that the process can be implemented at low cost and with little development effort and can be easily integrated into an existing system with a PID. Furthermore, the process can be integrated into practical operation without the need for additional manual activities, saving the user time and money.

Preferably, the operating voltage of the PID is changed continuously or in discrete, at least almost equidistant steps in a range from zero volts to the typical operating voltage (to a predefined operating voltage) of the PID.

Typical operating voltage is the voltage recommended by the manufacturer of the PID or lamp for operation and defined in the technical data sheet, for example 3 volts. The typical operating voltage is a characteristic value and is determined by the design (configuration) of the PID or lamp.

Accordingly, the operating voltage is changed at least partially in a range from zero volts to the typical operating voltage of the PID. Advantageously, the voltage range is selected so that it is as small as possible, but sufficient values are available for a reliable evaluation. This essentially shortens the time required by the procedure. The voltage range must include at least the typical ignition voltage of the lamp of the PID.

It is particularly advantageous to change the operating voltage in discrete, at least almost equidistant steps, for example in a time interval of one second. The operating current is measured at each step and the measurement of the operating current is synchronized with the change in the operating voltage. This ensures that the operating current is measured at the times at which a change in operating voltage has also taken place.

In a preferred embodiment of the process, the operating state of the PID is evaluated on the basis of the course of the operating current as a function of the change in the operating voltage and/or on the basis of the time course of the operating current over time.

The basis of the evaluation is therefore the course of the operating current as a function of the operating voltage or the course of the operating current as a function of time. Advantageously, the determination and evaluation of the course of the operating current as a function of the operating voltage decouples the process from time. This means that the operating voltage can be changed flexibly over time and a fixed time interval for a change in the operating voltage is not necessary. If the course of the operating current is determined and evaluated as a function of time, this has the advantage that the operating voltage does not have to be measured and/or the individual voltage values do not have to be stored and assigned to an operating current value. It must be ensured that the change in the operating voltage occurs evenly and at the same time intervals. This means that the measured operating current values are assigned to points in time and/or time periods. For example, the change is 0.1 volts per second.

According to a particular embodiment of the invention, the result value is marked as incorrect if there is an unexpected course of the operating current.

If it is not possible to clearly determine whether the lamp has ignited or not when evaluating the operating current, it is not possible to determine the operating state of the PID. An unexpected course of the operating current is present, for example, if it remains constant when the operating voltage changes and/or two different states were determined with regard to the ignition of the lamp when at least a second evaluation was carried out. In such cases, the result value is marked as incorrect. Advantageously, the identification of the result value as faulty can be used to initiate measures and/or to inform about an undetectable operating state of the PID, for example via an output unit. The result value can be identified, for example, by an additional status value. Furthermore, the identification can, for example, be a third result value in addition to the positive and negative result value.

In a particularly preferred embodiment, the result value is forwarded to an output unit.

In an advantageous way, a user is thus informed directly about the determined operating status of the PID and has the option of initiating appropriate actions. Actions can include, for example, carrying out a gas measurement if the result value is positive or changing the PID if the result value is negative and/or incorrect. An output unit can be, for example, a display and/or a light-emitting diode, an acoustic and/or a haptic signal transmitter. Furthermore, an output unit can, for example, be able to forward a result value as digital and/or analog information.

Preferably, the following steps of the process according to the invention are repeated at least once:
changing an operating voltage of the photoionization detector in a voltage range and measuring a resulting operating current of the photoionization detector,
evaluation of an operating state of the photoionization detector on the basis of a course of the operating current, and
generation of a result value which has at least one piece of information about the operating state of the photoionization detector in relation to a switched-on state of the lamp.

This is an advantageous way of verifying and, if necessary, correcting false-negative, false-positive or incorrectly identified result values. A false-negative result value is a negative result value, although the PID is capable of measurement. A false-positive result value is a positive result value, although the PID is not capable of measurement. The criteria and/or how often the procedure is repeated can, for example, be predefined and/or specified by the user. For example, it can be predefined that the procedure for evaluating the operating status of the PID is repeated for a result value that is identified as faulty. In another example, the user can repeat the procedure if it is determined that the procedure was performed at an operating temperature of the PID that is outside the permissible range for the PID.

A further preferred feature of the invention is that in the event that the result value indicates an operating state with the lamp of the photoionization detector switched on, i.e. the result value is positive, an ignition voltage is determined.

If a positive result value is determined, the evaluation has shown that the lamp of the PID has ignited. Accordingly, the ignition voltage of the lamp can be determined. Depending on the evaluation variant, for example, the operating voltage is determined as the ignition voltage at which the slope of the current curve has changed and/or the operating voltage at which, as previously described, a larger change in the operating current has taken place compared to other operating current changes.

According to a further particular embodiment of the invention, the ignition voltage is used to determine a sensor vitality.

In an advantageous way, the ignition voltage can provide a user with information about the sensor vitality of the PID. The sensor vitality indicates whether it can be assumed that the PID will fail in the foreseeable future, i.e. will no longer be able to measure. This may be the case, for example, if the PID has already been in use for a long time.

Preferably, the determination of the sensor vitality is based on defined voltage ranges, whereby a sensor vitality value is assigned to each voltage range. A sensor vitality value is assigned according to the voltage range in which the determined ignition voltage lies.

For example, sensor vitality values are available in three gradations: very good, good and poor. Very good can mean, for example, that the PID can still be used for a large number of measurements, e.g. at least 100. Good can mean, for example, that the PID can still be used for many measurements, e.g. 50. Poor can mean, for example, that the PID can only be used for a few measurements, e.g. a maximum of 10. The definition of the voltage ranges depends on the respective design of the PID and can be determined empirically.

Preferably, the determined sensor vitality is forwarded to an output unit.

An output unit can be, for example, a display and/or a light-emitting diode, an acoustic and/or haptic signal transmitter. Furthermore, an output unit can, for example, be able to forward a sensor vitality value as digital and/or analog information. In an advantageous way, the user can, for example, be warned and/or informed that the PID and/or the lamp will soon need to be changed. Preferably, the output unit for forwarding the sensor vitality value is at least partially identical to the aforementioned output unit for forwarding the result value.

According to the invention, a PID with a device comprising the following is proposed:
a power supply unit for changing the operating voltage,
a measuring unit for measuring a resulting operating current, and
an evaluation unit for evaluating an operating state of the photoionization detector on the basis of a course of the operating current and for generating a result value which has at least one item of information about the operating state of the photoionization detector in relation to a switched-on state of the lamp.

A PID with a device that is suitable for carrying out the process according to the invention offers the particular advantage that it can be integrated into a gas measuring device without great effort and offers the additional function of evaluating the operating status of the PID. PIDs are already extensively used as gas sensors in gas measuring devices. This means that the basic components for measuring a gas with a PID are already present in a gas measuring device.

The power supply unit can be a voltage regulator or a digital-to-analog converter, for example. A measuring unit can be an analog-to-digital converter, for example. An evaluation unit can be a microcontroller, for example. Preferably, the microcontroller already comprises a suitable digital-to-analog converter and/or a suitable analog-to-digital converter, so that these are at least partially omitted as individual components.

A further preferred feature of the invention is that the device described above comprises at least one data interface which is suitable for forwarding information from the evaluation unit.

Thus, when integrating the PID with the device, which is suitable for carrying out the process according to the invention, into a gas measuring device, for example, only the software of the gas measuring device needs to be slightly adapted in order to interpret the result value and/or the sensor vitality value and make it accessible to the user.

Such a data interface may also be connected to the gas measuring device wirelessly and/or by wire.

According to the invention, a gas measuring device with a PID (photoionization detector) and a device comprising the following is provided:
a power supply unit for changing the operating voltage of the PID,
a measuring unit for measuring an operating current of the PID,
an evaluation unit for evaluating an operating state of the photoionization detector on the basis of a course of the operating current and for generating a result value which has at least one item of information about the operating state of the photoionization detector in relation to a switched-on state of the lamp, and
an output unit for displaying the result value.

A gas measuring device with a PID and a device suitable for carrying out the process according to the invention offers the particular advantage that the PID does not have to be supplemented by an additional device. This means, for example, that an existing PID can be used in the gas measuring device.

The power supply unit can, for example, have a voltage regulator or a digital-to-analog converter. A measuring unit can, for example, have an analog-to-digital converter. An evaluation unit can have a microcontroller, for example. Preferably, the microcontroller already has a suitable digital-to-analog converter and/or a suitable analog-to-digital converter. Particularly preferably, the microcontroller already existing in the gas measuring device can be used, especially if the microcontroller has a suitable digital-to-analog converter and/or a suitable analog-to-digital converter. This has the advantage that the gas measuring device does not have to be supplemented, at least in part, with additional components.

Furthermore, a combination of the above may be provided, whereby the components of the PID with a device are at least partially contained in the gas measuring device with a PID and vice versa.

Further features, functions and effects of the invention are shown in the description and the accompanying figures. Examples of embodiments of the invention are described without limiting the general idea of the invention. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a PID with a device for detecting its operating state;

FIG. 2 is a schematic graph representation of two current intensity courses of the operating current for different operating states of a PID;

FIG. 3 is a schematic view of a gas measuring device with a PID and a device for detecting the operating state of the PID; and

FIG. 4 is a flow chart of one embodiment of the process according to the invention.

### DESCRIPTION OF PREFERRED EMBODIMENTS

In the following, embodiments of the invention are described in detail with reference to the attached figures. The same components in several figures are each provided with the same reference characters.

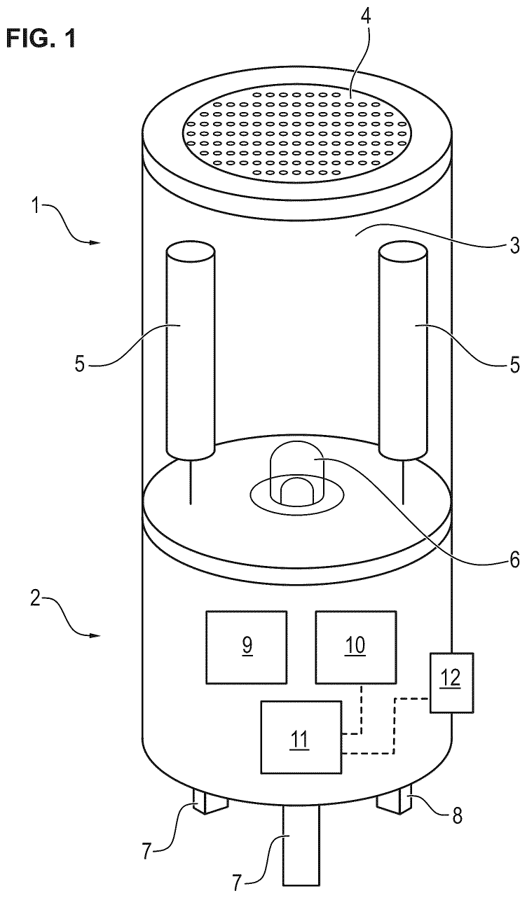

FIG. 1 schematically shows a PID 1 with a device 2 for detecting the operating status of the PID. The PID has a gas inlet with a porous membrane 4 through which air, which may contain volatile organic compounds (VOCs), enters the measuring chamber 3.

If volatile organic substances enter the measuring chamber, they are ionized by the UV light emitted by the lamp 6. This releases electrons from the molecules of the VOC, which are absorbed by the electrodes 5 and lead to a current flow. This current is the measurement signal of the PID, which corresponds to the concentration of the VOC. Accordingly, the higher the concentration of the VOC, the greater the current. The measurement signal is output at connector 8. The connectors 7 are used for the external power supply of the PID and the device 2.

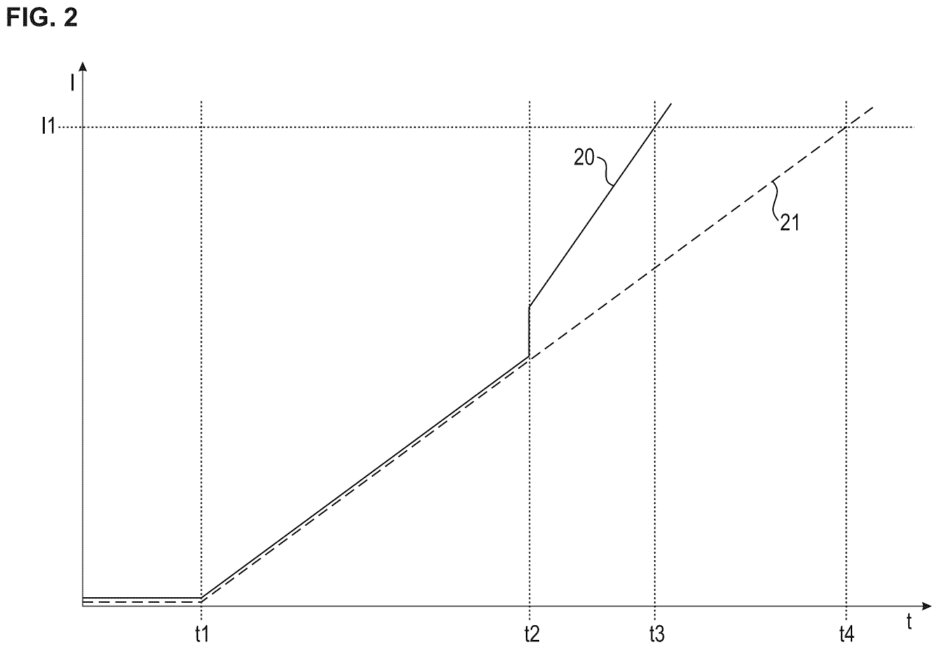

The device 2 in FIG. 1 comprises a power supply unit 9, which is designed to change the operating voltage of the PID, as well as a measuring unit 10, an evaluation unit 11 and a data interface 12. The power supply unit 9 has a voltage regulator, which is suitable for increasing the operating voltage in specific, equidistant steps. The measuring unit 10 has an analog-to-digital converter that is suitable for measuring an operating current of the PID. The evaluation unit 11 has a connection, shown as a dashed line, for receiving measured values from the measuring unit 10. The evaluation unit 11 has a microcontroller and evaluates the course of the measured operating current, as explained below in connection with the description of FIG. 2, and generates a result value. The result value indicates whether the lamp has ignited, i.e. is switched on and the PID is capable of measuring, whether the lamp has not ignited and the PID is not capable of measuring, or whether the operating status cannot be determined. The data interface 12 has a data connection, shown as a dashed line, with the evaluation unit 11 and makes this result value available to external components in digital form. The data interface 12 is configured for wireless and/or wired transmission of data.

FIG. 2 schematically shows two current intensity courses 20, 21 of the measured operating current for different operating states of the PID as a function of the time t in which the operating voltage of the PID is increased uniformly and at equal time intervals from almost zero volts to the typical operating voltage. Alternatively, a schematic representation of the current intensity courses 20, 21 of the measured operating current for different operating states of the PID as a function of the operating voltage may be provided, whereby the operating voltage of the PID is increased uniformly from almost zero volts to the typical operating voltage. In this case, the courses as a function of time and as a function of voltage are equivalent. The current intensity course of the measured operating current 20 shows a representative course of a measurable PID. The current intensity course of the measured operating current 21 shows a representative course of a PID that cannot be measured, which is measured when the lamp of the PID does not ignite.

With the uniform increase in the operating voltage of the PID, the current intensity courses 20 and 21 increase. The current intensity courses of the measured operating currents 20 and 21 are essentially linear and at least almost the same up to time t2.

At time t2, the current intensity course of the operating current 20 increases abruptly, while the current intensity course of the operating current 21 continues to increase essentially linearly. The sudden increase in the current intensity course of the operating current 21 is due to the fact that the lamp of the PID has ignited.

In contrast to the operating current 21, which continues to increase linearly, i.e. with the same slope, the slope of the operating current 20 changes from time t2. The current intensity course of the operating current 20 now increases more than before time t2. This means that the current intensity of the reference current I1 is reached much earlier at time t3 than if the lamp had not ignited and there had been no sudden increase and/or no steeper slope in the current intensity course of the operating current 20, as is the case in the current intensity course of the operating current 21.

A non-linear jump at the time of ignition of the PID's lamp and a subsequent steeper slope of the current intensity course are therefore characteristic of the current intensity course of the operating current of a PID capable of measurement when the operating voltage changes uniformly. If the lamp is not ignited, the current intensity of the operating current is essentially linear. According to the two current intensity courses of the operating currents 20 and 21 shown in FIG. 2, the operating state of a PID, and thus its measuring capability, can be reliably recognized. The time t4 at which the reference current I1 is reached is recorded and then, as described above, compared with a calculated value resulting from the interpolation of the current intensity course before the typical ignition voltage. If the calculated value is greater than the recorded value, the lamp has ignited and the PID can be measured.

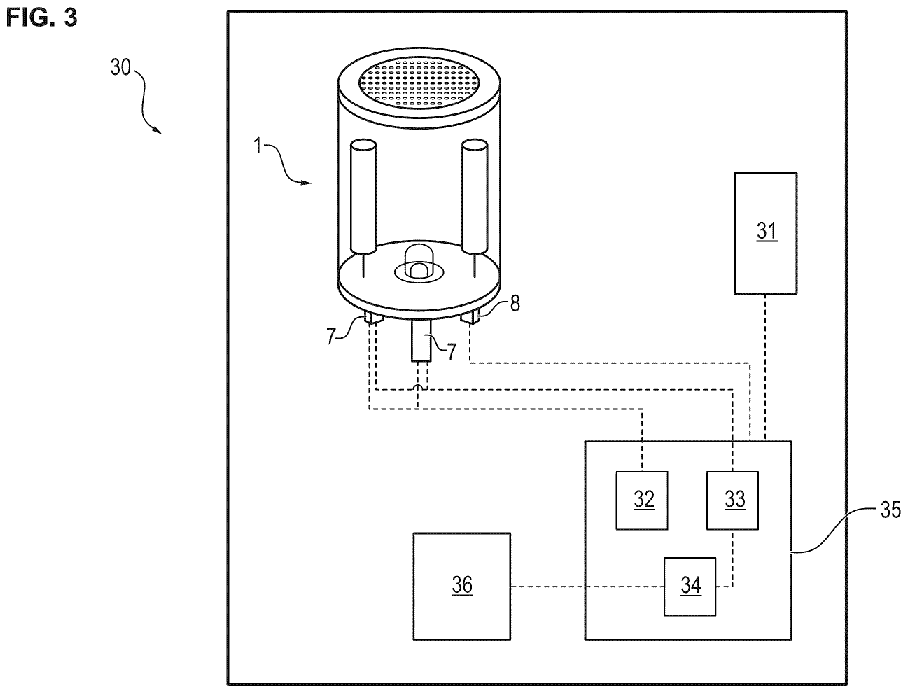

FIG. 3 schematically shows a gas measuring device 30 with a PID 1 and a device 35 for detecting the operating status of the PID. Furthermore, the gas measuring device 30 comprises a further gas sensor 31 as an example. Such a further gas sensor 31 can be an electrochemical, catalytic, infrared or PID sensor. According to the embodiment example shown in FIG. 3, the additional gas sensor 31 is configured as an electrochemical gas sensor.

The device 35 comprises a power supply unit 32, a measuring unit 33, an evaluation unit 34 and is connected to the connector for outputting a measuring signal 8 of the PID 1 and the additional gas sensor, shown as a dashed line. The power supply unit 32 is configured to change the operating voltage of the PID 1 and has a digital-to-analog converter. Furthermore, there is an electrical connection between the power supply unit 32 and a plug connector 7 for the external voltage supply of the PID 1, which is shown as a dashed line. The measuring unit 33 is suitable for measuring an operating current of the PID 1 and has an analog-to-digital converter. The measuring unit also has a connection to the plug connector 7 for the external power supply of the PID 1. The evaluation unit 34, which is connected to the measuring unit 33, evaluates the operating state of the PID 1. In the process, the course of the current strength of the measured operating current is evaluated when the operating voltage is increased, as described above, and a result value is generated. The result value is positive if it is recognized that the lamp has been switched on, i.e. has ignited, and the PID is capable of measuring. If the operating state deviates from this, the result value is negative, namely when it has been detected that the lamp has not ignited and the PID is not capable of measuring.

In the embodiment example according to FIG. 3, the device 35 is configured as a microcontroller of the gas measuring device 30. This has the advantage that the gas measuring device does not have to have any further processor components and the device 35 carries out the process according to the invention and also the calculation of the gas measurement values of the PID 1 and the other gas sensor 31. Alternatively, the gas measuring device may comprise a microcontroller, not shown, which determines the measured gas values, and the device 35 is designed as a microcontroller which executes the process according to the invention.

The output unit 36 has a connection, shown as a dashed line, with the evaluation unit 34 and is configured to display the result value and thus inform the user of the gas measuring device 30 whether the PID 1 is functioning properly and is capable of measuring. The output unit 36 according to FIG. 3 has a display in which the result value is shown in the form of a self-explanatory graphic as soon as the result value is available. Furthermore, in addition to the display, the output unit 36 comprises an at least two-color LED, whereby a positive result value is displayed with one color and a negative result value is displayed with a different color.

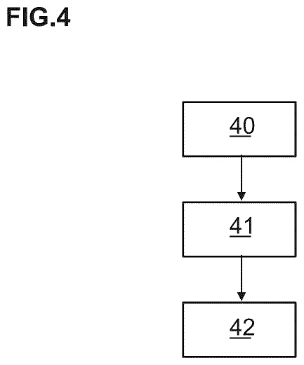

FIG. 4 shows a flow chart of a preferred embodiment of the process according to the invention. In a first process step 40, the operating voltage of the PID is changed in a voltage range from zero volts to the typical operating voltage and the resulting operating current of the PID is measured. In a subsequent, second process step 41, the operating state of the PID 1 is evaluated on the basis of the operating current course. A linear equation is established for the essentially linear course of the operating current that results before the ignition voltage of the PID 1 is reached. The linear equation is used to calculate a reference time and/or reference period at which the reference current I1 is obtained. Furthermore, the time and/or period at which the reference current I1 was measured is determined. The reference point in time and the point in time and/or the reference period and the period are then compared with each other. If the reference time is greater than the time and/or the reference period is greater than the time period, the lamp has ignited, otherwise the lamp has not ignited. On the basis of this evaluation, in the third process step 42, a result value is obtained which has information about the operating state of the PID 1 in relation to a switched-on state of the lamp 6. If the lamp has ignited, the PID can be measured, and the result value is positive. If it is determined that the lamp has not ignited, the PID cannot be measured, and the result value is negative. If it could not be determined whether the lamp has ignited or not, for example because the reference current I1 is not reached and therefore cannot be measured, the result value is incorrect. In this case too, the user should assume that the PID is not capable of measuring and take appropriate measures, such as repeating the procedure or replacing the PID.

The invention has been described above with reference to preferred embodiments and illustrated in the figures. These descriptions and illustrations are purely schematic and do not limit the scope of protection of the claims, but serve only to illustrate them by way of example. It is understood that the invention can be implemented and modified in a variety of ways and that individual features of the embodiments can be freely combined with one another, where technically expedient, without departing from the scope of protection of the patent claims. While specific embodiments of the invention have been shown and described in detail to illustrate the application of the principles of the invention, it will be understood that the invention may be embodied otherwise without departing from such principles.

### LIST OF REFERENCE CHARACTERS

1 PID (photoionization detector)
2 Device for detecting an operating state
3 Measuring chamber
4 Gas inlet with porous membrane
5 Electrodes
6 Lamp
7 Connector for external power supply
8 Connector for outputting a measurement signal
9 Power supply unit within a device
10 Measuring unit within a device
11 Evaluation unit within a device
12 Data interface
20 Current intensity course (curve) of the operating current of a PID with igniting lamp
21 Current intensity course (curve) of the operating current of a PID with non-igniting lamp
30 Gas measuring device
31 Further gas sensor
32 Power supply unit within a gas measuring device
33 Measuring unit within a gas measuring device
34 Evaluation unit within a gas measuring device
35 Device inside a gas measuring device
36 Output unit
40 First process step
41 Second process step
42 Third process step

What is claimed is:

1. A process for detecting an operating state of a photoionization detector, which detector comprises a lamp for generating ultraviolet light, the process comprising the steps of:
changing an operating voltage of the photoionization detector in a voltage range and measuring a resulting operating current of the photoionization detector;
evaluating an operating state of the photoionization detector based on a course of an operating current; and
generating a result value which comprises information about an operating state of the photoionization detector in relation to a switched-on state of the lamp.

2. A process according to claim 1, wherein the operating voltage of the photoionization detector is changed continuously or in discrete, at least essentially equidistant steps in a range from 0 volts to a typical operating voltage of the photoionization detector.

3. A process according to claim 1, wherein the evaluation of the operating state of the photoionization detector is carried out based on the course of the operating current as a function of the change in the operating voltage and/or based on the course of the operating current as a time course of the operating current.

4. A process according to claim 1, wherein the result value is characterized as erroneous if the course of the operating current comprises an unexpected course.

5. A process according to claim 1, wherein the result value is forwarded to an output unit.

6. A process according to claim 1, wherein the following is repeated at least once:
changing the operating voltage of the photoionization detector in the voltage range and measuring the resulting operating current of the photoionization detector;
evaluating the operating state of the photoionization detector based on the course of the operating current; and
generating the result value which comprises information about an operating state of the photoionization detector in relation to a switched-on state of the lamp.

7. A process according to claim 1, wherein in the event that the result value indicates an operating state with the lamp of the photoionization detector switched on, an ignition voltage is determined.

8. A process according to claim 7, wherein the ignition voltage is used to determine a sensor vitality.

9. A process according to claim 8, wherein the determination of the sensor vitality is based on defined voltage ranges, wherein a sensor vitality value is assigned to each voltage range and wherein the determined ignition voltage is assigned to one of the defined voltage ranges.

10. A process according to claim 8, wherein the determined sensor vitality is forwarded to an output unit.

11. A photoionization detector comprising a lamp for generating ultraviolet light and a device, the device comprising:
a power supply unit configured to change an operating voltage;
a measuring unit configured to measure a resulting operating current; and
an evaluation unit configured to evaluate an operating state of the photoionization detector based on a course of the operating current and to generate a result value which comprises information about an operating state of the photoionization detector in relation to a switched-on state of the lamp.

12. A photoionization detector according to claim 11, wherein the device further comprises at least one data interface which is configured to forward information from the evaluation unit.

13. A photoionization detector according to claim 11, wherein the power supply unit is configured to change the operating voltage of the photoionization detector continuously or in discrete, at least essentially equidistant steps in a range from 0 volts to a typical operating voltage of the photoionization detector.

14. A photoionization detector according to claim 11, wherein the evaluation of the operating state of the photoionization detector is carried out based on the course of the operating current as a function of the change in the operating voltage and/or based on the course of the operating current as a time course of the operating current.

15. A photoionization detector according to claim 14, wherein evaluation unit is configured to characterize the result value as erroneous if there course of the operating current comprises an unexpected course.

16. A photoionization detector according to claim 11, wherein in the event that the result value indicates an operating state with the lamp of the photoionization detector switched on, an ignition voltage is determined.

17. A photoionization detector according to claim 16, wherein the ignition voltage is used to determine a sensor vitality.

18. A photoionization detector according to claim 17, wherein the determination of the sensor vitality is based on defined voltage ranges, wherein a sensor vitality value is assigned to each voltage range and wherein the determined ignition voltage is assigned to one of the defined voltage ranges.

19. A photoionization detector according to claim 17, wherein the device further comprises at least one data interface which is configured to forward information from the evaluation unit wherein the determined sensor vitality is forwarded to the at least one data interface.

20. A gas measuring device comprising a photoionization detector comprising a lamp for generating ultraviolet light and a device, the device comprising:
a power supply unit configured to change an operating voltage of the photoionization detector;
a measuring unit configured to measure an operating current of the photoionization detector;
an evaluation unit configured to evaluate an operating state of the photoionization detector based on a course of the operating current and to generate a result value which comprises information about an operating state of the photoionization detector in relation to a switched-on state of the lamp; and
an output unit for displaying the result value.
